(19) United States
(12) Patent Application Publication
(10) Pub. No.: US 2005/0212688 A1
(43) Pub. Date: Sep. 29, 2005

(54) Power line communication based supplemental service meter gateway and casing structure thereof, power line communication system and method using same

(75) Inventor: Beom-Jin Chung, Seoul (KR)

Correspondence Address: MARGER JOHNSON & MCCOLLOM, P.C., 210 SW MORRISON STREET, SUITE 400, PORTLAND, OR, 97204, US

(73) Assignee: Xeline Co., Ltd., Seoul (KR)

(21) Appl. No.: 11/078,589

(22) Filed: Mar. 11, 2005

(30) Foreign Application Priority Data
Mar. 12, 2004 (KR) 2004-16793

(51) Int. Cl. G08C 15/06; G08B 23/00

(52) U.S. Cl. 340/870.02

(57) ABSTRACT

The present invention relates to a power line communication based supplemental service meter gateway and a casing structure thereof, a power line communication system and a method using the same, in which a supplemental service meter gateway is provided whereby value-added services are provided in addition to remote meter readings based on a power line communication network, and power inspection for remote readings and service measurements in response to the value-added services can be respectively and independently implemented.

### BACKGROUND OF THE INVENTION

### FIELD OF THE INVENTION

The present invention relates to a power line communication based supplemental service meter gateway and a structure thereof, a power line communication system and a method using the same and, more particularly, to a power line communication based supplemental service meter gateway and a casing structure thereof, a power line communication system and a method using the same, in which value-added services are provided in addition to remote meter readings based on a power line communication network. And power inspection for remote readings and service measurements in response to the value-added services can be respectively and independently implemented.

Generally, in a Power Line Communication (PLC), high frequency signals connect with low-voltage or high-voltage power distribution lines installed indoors or outdoors of residential homes to transmit voice, data signals or the like at a high speed.

Particularly, with the development of information devices, there has been a high demand to intelligently control consumers' home appliances, such as connecting televisions, personal computers, video cameras and the like, such that much research has been conducted on high-speed power line communications in home networks.

Recently, with the rapid development of power line communication (PLC) modem technology, a high-speed transmission in several Mbps grades can be made possible, and as a result, the PLC technology has emerged as another new access network that can compete with ADSL (Asymmetric Digital Subscriber Line) or cable modem using coaxial cables.

If the above-mentioned PLC technology becomes commercialized, power providers can directly utilize networks for upgraded power information services such as Automatic Meter Reading (AMR), power distribution automatization and the like, and can anticipate profits from circuit leasing by providing high-speed information transport services. In the PLC, attempts have been made to provide value-added service functions in addition to remote metering applications as networks including wireless communication have become readily accessible and high-speed interactive communication has materialized. The value-added service mentioned herein refers to service data and content data provided through data communication networks.

However, it is still premature to expect high-grade technology that can provide value-added service functions in addition to remote metering. Furthermore, no alternatives have been provided with regard to calibration, security, authorization, control, management and the like for providing value-added services.

### SUMMARY OF THE INVENTION

The present invention is disclosed to solve the afore-mentioned problems and it is an object of the present invention to provide a power line communication based supplemental service meter gateway by which value-added services are provided in addition to remote meter readings based on a power line communication network, and power inspection for remote readings and service measurements in response to the value-added services can be respectively and independently implemented.

It is another object of the present invention to provide a power line communication based supplemental service meter gateway configured to independently operate a value-added service function based on the power inspection and interactive data communication, such that, while functions of power metering and interactive data communication are maintained, value-added service measurements are made to be functionally independent to thereby allow the power measurement function and the service measurement function to be independently controlled by a single meter gateway.

It is another object of the present invention to provide a value-added service inspection method adapted to use a supplemental service meter gateway for stably metering the value-added service.

It is still another object of the present invention to provide a power line communication system and a method using the same adapted to use a supplemental service meter gateway for stably implementing remote meter readings and value-added service meter readings, and stably providing value-added service data, whereby the rates or cost of the remote meter readings and value-added meter readings can be effectively levied.

It is still a further object of the present invention to provide a power line communication system and a method adapted to use a value addition type meter gateway for stably implementing remote meter readings and stably providing a value-added service data, data security and data control and verification of use of value-added service data.

In accordance with one aspect of the present invention, there is provided a supplemental service meter gateway comprising: a power measurer for implementing a high-speed power line communication with a regional information control device via subscriber networks, implementing a high-speed power line communication with terminals of dwellings via residential home indoor networks, and reading the accumulated power of the dwellings from the residential home indoor networks to provide the reading data to the regional information control device via the subscriber networks; and a service measurer for providing to the terminals service data supplied from the regional information control device via the subscriber networks in response to a request signal from the terminals and measuring the service data based on the type of service/content, used service time, service/content download frequency, content information quantity, unit information, and control service provision frequency to transmit the measured service reading data to the regional information control device.

In accordance with another aspect of the present invention, there is provided a casing structure of a supplemental service meter gateway comprising: a terminal casing including an input terminal into which an outdoor incoming line constituting the subscriber networks is inputted, and an output terminal out of which an indoor incoming line constituting the residential home indoor network is outputted, where the input terminal and the output terminal are arranged in parallel; a power measurer casing connected to an upper end of the terminal casing, and intrinsically disposed with the power measurer, wherein a first cover coupled to the upper end of the terminal casing by a first sealing member is disposed at the front of the power measurer casing; and a service measurer casing attached and detached by an upper end of the power measurer casing and a support member, and intrinsically disposed with a service measurer, wherein a second cover coupled to the upper end of the power measurer casing by a second sealing member is disposed at the front of the service measurer casing.

In accordance with still another aspect of the present invention, there is provided a power line communication system using a supplemental service meter gateway.

In accordance with still a further aspect of the present invention, there is provided a power line communication method, the method comprising the steps of: (a) registering a common code key and/or private code key with a regional information control device, a supplemental service meter gateway, a residential home indoor information control device and a terminal; (b) prompting a subscriber to manipulate the residential home indoor information control device to transmit a service data request signal to an external server; (c) prompting the outside server to transmit service data to the regional information control device via data communication network in response to the service data request signal; (d) prompting the regional information control device to encode the service data by using the common code key, and transmitting a first encoded data to the supplemental service meter gateway via subscriber networks; (e) prompting the supplemental service meter gateway to decode the first data by using the common code key and then to encode the first data again by using the private code key, and to transmit a second encoded data to the residential home indoor information control device and the terminal via the residential home indoor network, and to measure the decoded first data based on type of service/content, used service time, service/content download frequency, content information quantity, unit information, and control service provision frequency to again encode the measured reading data by using the common code key and to transmit a third encoded data to the regional information control device via the subscriber networks; (f) prompting the regional information control device to use the common code key to decode the third data and to transmit the decoded third data to the external server via the data communication network; and (g) prompting the external server to allocate a service data rate based on the decoded third data.

### BRIEF DESCRIPTION OF THE DRAWINGS

For a better understanding of the nature and objects of the present invention, reference should be made to the following detailed description with the accompanying drawings, in which:

FIG. 1 is an overall block diagram for illustrating a supplemental service power line communication system according to an embodiment of the present invention;

FIG. 2 is a schematic block diagram for illustrating subscriber networks and residential home indoor networks of the service addition type power line communication system of FIG. 1;

FIG. 3 is a detailed block diagram of a regional information control device illustrated in FIG. 1;

FIG. 4 is a detailed block diagram of a supplemental service meter gateway illustrated in FIG. 1;

FIGS. 5a to 5e are structural drawings of a casing of the supplemental service meter gateway illustrated in FIG. 4; FIG. 6 is a block diagram of a residential home indoor information control device illustrated in FIG. 2;

FIGS. 7a and 7b are outside views of the residential home indoor information control device illustrated in FIG. 6;

FIG. 8 is a block diagram of a terminal illustrated in FIG. 2;

FIG. 9 is a block diagram of a remote controller;

FIG. 10 is an outside view of the remote controller illustrated in FIG. 9;

FIGS. 11a to 11b are block diagrams for explaining data encoding/decoding process using a common code key; and

FIGS. 12a to 12b are block diagrams for explaining data encoding/decoding process using a private code key.

### DETAILED DESCRIPTION OF THE PREFERRED EMBODIMENT

The preferred embodiment of the present invention will now be described in detail with reference to the annexed drawings, where the present embodiment is not limiting the scope of the present invention but is given only as an illustrative purpose.

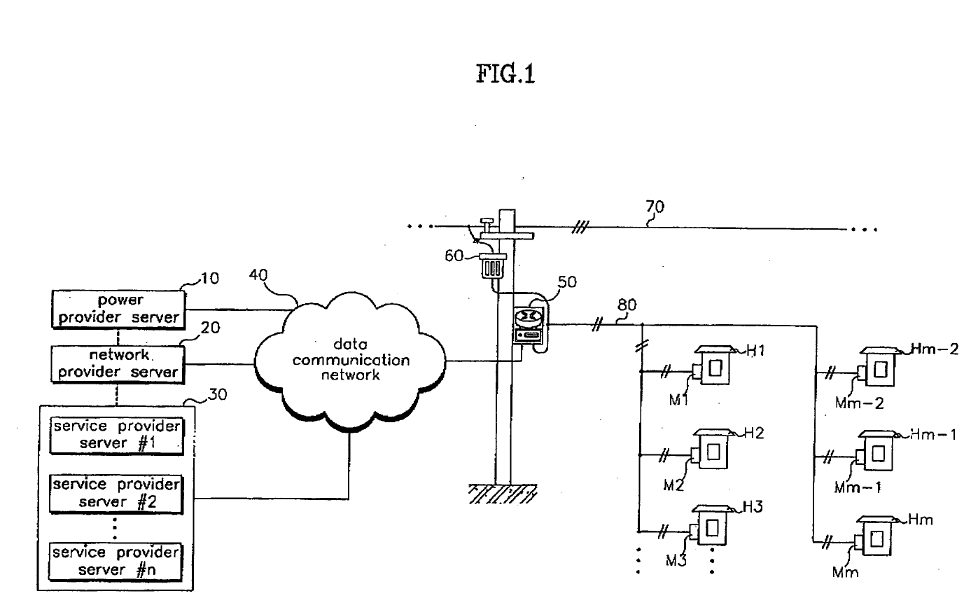

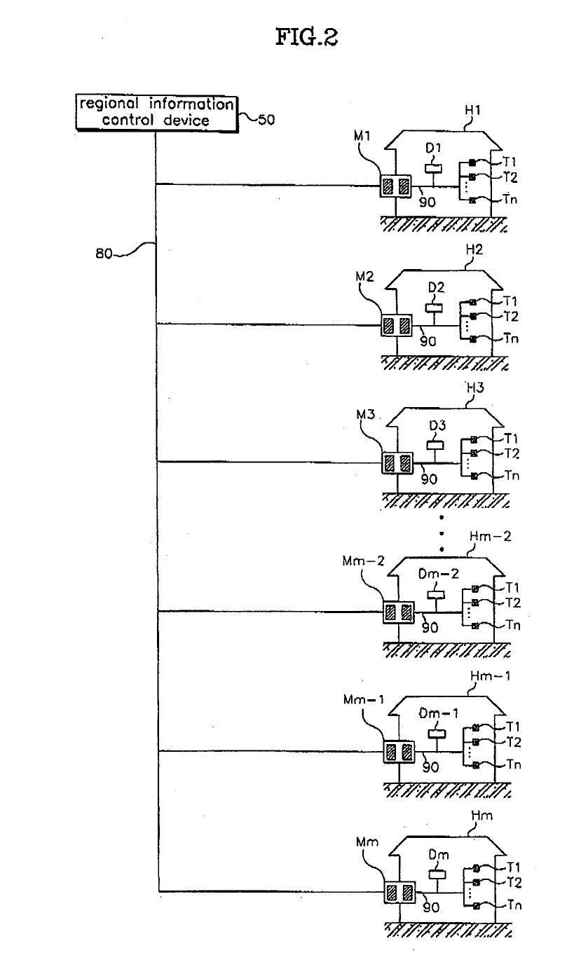

FIG. 1 is an overall block diagram for illustrating a supplemental service power line communication system according to an embodiment of the present invention, and FIG. 2 is a schematic block diagram for illustrating subscriber networks and residential home indoor networks of the supplemental service power line communication system of FIG. 1, where the subscriber networks are the networks formed via outdoor incoming lines (80), and the residential home indoor networks are the networks formed via indoor incoming lines (90).

Referring to FIGS. 1 and 2, a supplemental service power line communication system according to the preferred embodiments of the present invention includes a regional information control device (50) for conducting a high-speed interactive communication with an external server via a data communication network (40), meter gateways (M1 to Mm) for conducting a high-speed power line communication via the regional information control device (50) and the outdoor incoming line (80), residential home indoor information control devices (D1 to Dm) for conducting a high-speed power line communication via the indoor incoming line (90) with the meter gateways (M1 to Mm) inside the residential homes; and a plurality of terminals (T1 to Tn) for conducting a high-speed power line communication with the residential homes at the residential home indoor information control devices (D1 to Dm) inside the residential homes.

[External Server ]

The external server includes a power provider server (10), a network provider server (20) and a plurality of service provider servers (30), and performs a high-speed interactive communication with a plurality of regional information control devices (50) via a data communication network (40, for example, broadband integrated communication network, broadband communication network, Internet, local area network or the like) based on Transmission Control Protocol/Internet Protocol (TCP/IP). The above-mentioned power provider server (10), the network provider server (20) and the service provider server (30) are interconnected via data communication networks (40) or other communication networks.

The power provider server (10) receives in real time power meter readings of each dwelling (H1 to Hm) from the regional information control device (50) via the data communication network (40). The power meter readings herein mentioned refer to power quantities used by each dwelling (H1 to Hm). The power provider server (10) allocates used power rates of each dwelling and levies the rates on the dwellings based on power readings provided by the regional information control device (50). The power readings mentioned herein may refer to a total sum of monthly, weekly, nightly, daily and timely used power quantities of all dwellings allocated to a single regional information control device (50), and monthly, weekly, nightly, daily and timely used power quantities and instantaneous power quantities of each dwelling (H1 to Hm).

The network provider server (20) is provided in real time with service meter readings of each dwelling (H1 to Hm) from the regional information control device (50) via the data communication network (40). The herein-mentioned service meter readings include various types of service/content, time of service/content and quantities of service/content used by subscribers and the like.

The network provider server (20) allocates used service rates of each dwelling (H1 to Hm) and levies the rates on the dwellings based on the service readings provided by the regional information control device (50). The herein-mentioried service readings may include monthly, weekly, nightly, daily and timely service used time, type of used service/content, used quantities of service/content and used frequencies of content and the like.

The plurality of service provider servers (30) provide service/content data to each meter gateway (M1 to Mm) via the data communication network (40) to cope with service models of each service company. In other words, the service provider servers (30) provide relevant service/content data via data communication network (40) when there is a request on the service/content data from each meter gateway (M1 to Mm).

Meanwhile, the external server may further include gas/piped water provider servers (not shown) and security control provider servers (not shown). The gas/piped water provider servers receive in real time gas/piped water readings of each dwelling (H1 to Hm) from the regional information control device (50) via the data communication network (40). The herein-mentioned gas/piped water readings refer to gas/piped water used in each dwelling (H1 to Hm). The gas/piped water provider server allocates used gas/piped water rates of each dwelling (H1 to Hm) based on used gas/piped water quantities provided by the regional information control device (50) and levies the rates on the dwellings.

The herein-mentioned gas/piped water readings may refer to a total sum of monthly, weekly, nightly, daily and timely used quantities of all dwellings (H1 to Hm) allocated to a single regional information control device (50), and monthly, weekly, nightly, daily and timely used quantities of each dwelling (H1 to Hm). The security control provider server represents a server controlling the security of each dwelling (H1 to Hm), and receives internal images of each dwelling (H1 to Hm) photographed by an Internet Protocol (IP) camera, for which charges are allocated and levied accordingly.

Hereinafter, the power readings and the gas/piped water readings provided to each meter gateway (M1 to Mm) are referred to as reading data, and the data, service/content data and other data provided from the service provider server (30) are referred to as service data.

[Regional Information Control Device]

Each subscriber network is provided with at least one or more regional information control devices (50) which in turn conduct a high-speed power line communication with all the meter gateways (M1 to Mm) constituting relevant subscriber networks.

The regional information control device (50) performs a high-speed power line communication with the meter gateways (MI to Mm), each gateway being installed at each dwelling (H1 to Hm), via the outdoor incoming line (80). Furthermore, the regional information control device (50) conducts data communication with the external server via data communication network (40). The herein-mentioned outdoor incoming line (80) refers to a 110V/220V distribution line extended from an output terminal of a pole transformer (60) and installed between the regional information control device (50) and each meter gateway (M1 to Mm).

The regional information control device (50) receives the reading data from the meter gateway (M1 to Mm) via the outdoor incoming line (80) and provides same to the power provider server (10) via the data communication network (40).

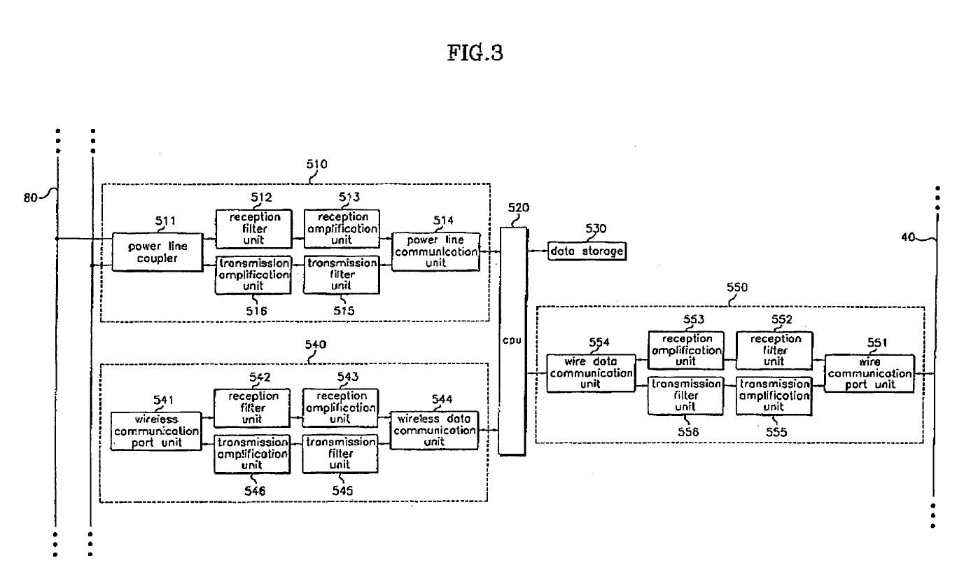

The regional information control device (50) temporarily stores the reading data transmitted from the meter gateways (M1 to Mm) at a data storage (reference numeral 530 in FIG. 3), and when there is a request signal with regard to the reading data from the power provider server (10), the regional information control device (50) fetches the reading data stored in the data storage and provides the data to the power provider server (10) via the data communication network (40). By this method, the regional information control device (50) receives the data readings, i.e., the gas/piped water readings, from the meter gateways (M1 to MM) and provides the data readings to a gas/piped water company server via the data communication network (40).

However, the regional information control device (50) thus described according to the preferred embodiment of the present invention is not limited thereto. The regional information control device (50) may sequentially fetch the gas/piped water readings or power readings according to a prior-established time and provides the data to the data communication network (40) when the prior-established transmission time arrives even if there is no request signal with regard to the power readings or gas/piped water readings from the power provider server (10) or from the gas/piped water company server.

Furthermore, the regional information control device (50) connects in real time the meter gateways (M1 to Mm), the network provider server (20) and the service provider server (30) via the data communication network (40).

The regional information control device (50) performs an Internet connection between the meter gateways (M1 to Mm) and the service provider server (30) when a signal is received requesting the Internet connection with the service provider server (30) from the meter gateways (M1 to Mm), whereby the service provider server (30) provides the service data to the meter gateways (M1 to Mm).

Furthermore, the regional information control device (50) stores (or registers) a common code key (K0) at a data storage (reference numeral 530 in FIG. 3) for conducting a security communication with each meter gateway (M1 to Mm), and when an encoded data is transmitted from the meter gateways (M1 to Mm), the regional information control device (50) uses the common code key (K0) to decode the encoded data. The herein-mentioned common code key (K0), which is a code key for the data frame in the power line communication using the outdoor incoming line (80), i.e., the subscriber network, is a code key for communication between the regional information control device (50) and the meter gateways (M1 to Mm). The encoded data provided from the meter gateways (M1 to Mm) represents encoded data using the common code key (K0).

Referring to FIG. 3, the regional information control device (50) includes a power line communication module unit (510), a central processing unit (520), a data storage (530), a wireless data communication module unit (540), a wire data communication module unit (550) and a power source unit (not shown) for supplying electric power. The power source unit uses electric power supplied via the outdoor incoming line (80).

The power line communication module unit (510) receives reading data from the outdoor incoming line (80). The power line communication module unit (510) receives an Internet access signal and other data from the outdoor incoming line (80), and also receives the service data received from the wire data communication module unit (550), reading data request call and control signal from the wire data communication module unit (550) for transmission via the outdoor incoming line (80). The power line communication module unit (510) includes a power line coupler (511), a reception filter unit (512), a reception amplification unit (513), a power line communication unit (514), a transmission filter unit (515) and a transmission amplification unit (516).

The power line coupler (511) is connected to the outdoor incoming line (80) to detect from the outdoor incoming door (80) the reading data, the Internet access signal and other data, i.e., reception data signal transmitted from the meter gateways (M1 to Mn) for transmission to the reception filter unit (512).

Furthermore, the power line coupler (511) transmits via the outdoor incoming line (80) the service data, the request signal and the control signal, i.e., the transmission data signal transmitted from the transmission amplification unit (516). The power line coupler (511) includes a transformer (not shown), a primary of which is connected to the outdoor incoming line (80), and a secondary of which is connected to the reception filter unit (512) and the transmission amplification unit (516). In addition, the power line coupler (511) may include a fuse, a varistor, a resistor, a Zener diode and the like for minimizing noise.

The reception filter unit (512) and the reception amplification unit (513) are data converters for converting the reception data signal. The reception filter unit (512) filters noise contained in the reception data signal transmitted from the power line coupler (511) or a predetermined frequency band for transmission to the reception amplification unit (513), while the reception amplification unit (513) amplifies the reception data signal filtered and transmitted via the reception filter unit (512) to a predetermined amplification rate for transmission to the power line communication unit (514).

The transmission filter unit (515) and the transmission amplification unit (516) are converters for converting the transmission data signal. The transmission filter unit (515) filters noise contained in the transmission data transmitted from the power line communication unit (514) or a predetermined frequency band for transmission to the transmission amplification unit (516), while the transmission amplification unit (516) amplifies the transmission data signal filtered and transmitted via the transmission filter unit (515) to a predetermined amplification rate for transmission to the power line coupler (511).

The power line communication unit (514) is a modulation/demodulation module intrinsically equipped with chips for power line communication, where a modulation/demodulation method thereof includes Orthogonal Frequency Division Multiplexing (OFDM), Code Division Multiple Access (CDMA) methods and the like. For example, the power line communication unit (514) demodulates the reception data signal transmitted from the reception amplification unit (513), i.e., analog signal, to a digital signal for transmission to the central processing unit (520). The transmission data signal transmitted from the central processing unit (520), i.e., the digital signal, is modulated to the analog signal for transmission to the transmission filter unit (515).

Meanwhile, the wire data communication module unit (550) receives the service data transmitted from the data communication network (40), the reading quantity request signal, a control signal and security data request signal of the power provider server (10), gas/piped water provider server and security control provider server.

Furthermore, the wire data communication module unit (550) provides the reading data to the power provider server (10) and the gas/piped water provider server via the data communication network (40) in response to the request signal, and also provides the security data to the security control provider server.

The wire data communication module unit (550) also provides the service data, request signal and the control signal to the central processing unit (520). The data provided to the central processing unit (520) is transmitted to the outside incoming line (80) via the power line communication module unit (510). The wire data communication module unit (550) includes a wire communication port unit (551), a reception filter unit (552), a reception amplification unit (553), a wire data communication unit (554), a transmission filter unit (556) and a transmission amplification unit (555). The wire communication port unit (551) which is a port connected to the data communication network (40) receives service data transmitted from an external server via the data communication network (40), the request signal, and the control signal and transmits same to the reception filter unit (552). Furthermore, wire communication port unit (551) transmits to the external server via the data communication network (40) the reading data transmitted from the transmission amplification unit (555), the Internet access signal, and other data.

The reception filter unit (552) and the reception amplification unit (553) are converters for converting the reception data signal, where the reception filter unit (552) filters noise contained in the reception data signal transmitted from the wire communication port unit (551) or a predetermined frequency band for transmission to the reception amplification unit (553), while the reception amplification unit (553) amplifies the reception data signal filtered and transmitted via the reception filter unit (552) to a predetermined amplification rate for transmission to the wire data communication unit (554).

The transmission filter unit (556) and the transmission amplification unit (555) are converters for converting the transmission data signal, where the transmission filter unit (556) filters noise contained in the transmission data signal transmitted from the wire data communication unit (554) or a predetermined frequency band for transmission to the transmission amplification unit (555), while the transmission amplification unit (555) amplifies the transmission data signal filtered and transmitted via the transmission filter unit (556) to a predetermined amplification rate for transmission to the wire communication port unit (551).

The wire data communication unit (554) demodulates the reception data signal transmitted from the reception amplification unit (553), i.e., an analog signal, to a digital signal for transmission to the central processing unit (520), or modulates the transmission data signal transmitted from the central processing unit (520), i.e., a digital signal, to an analog signal for transmission to the transmission filter unit (556).

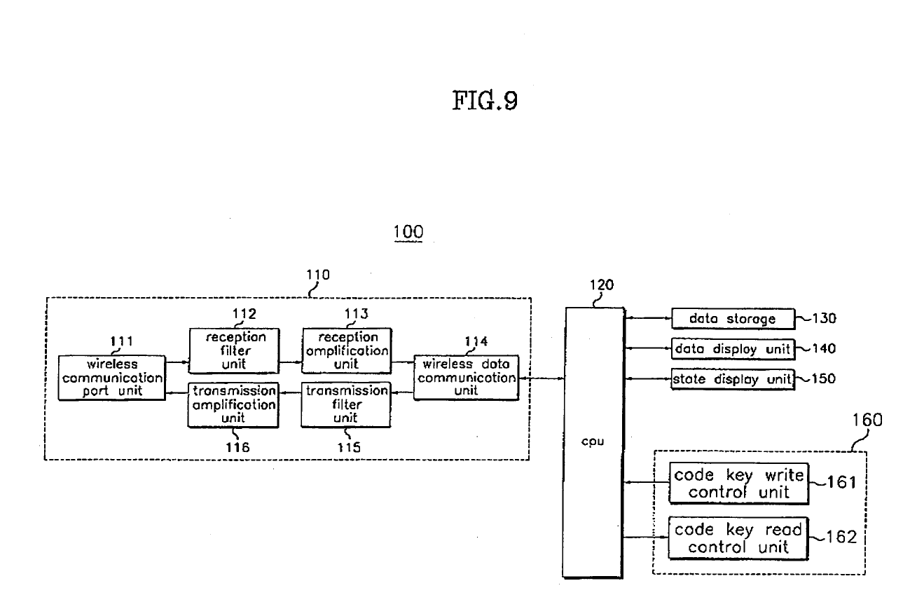

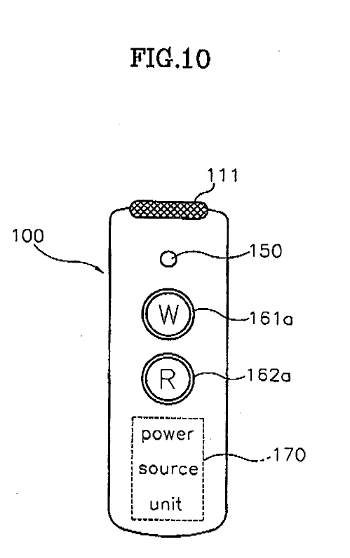

Meanwhile, the wireless data communication module unit (540) which is a wireless infrared communication module unit receives a common code key (K0) from mobile code key registration device such as Personal Digital Assistant (PDA), notebook computer or remote controller or the like, intrinsically equipped with wireless infrared communication device, for storage in the data storage (530). The PDA, the notebook and the remote controller may be controlled by a network provider. For example, a remote controller (100) is illustrated in FIGS. 9 and 10 and a detailed explanation thereto will be given later. The wireless data communication module unit (540) provides the common code key (K0) stored in the data storage (53) to a code key registration device when there is a request for the common code key (K0). The wireless data communication module unit (540) includes a wireless communication port unit (541), a reception filter unit (542), a reception amplification unit (543), a wireless data communication unit (544), a transmission filter unit (545) and a transmission amplification unit (546).

The wireless communication port unit (541), which is a wireless infrared communication port, includes a reception port (not shown) for receiving the common code key (K0) from the code key registration device for transmission to the reception filter unit (542), and a transmission port (not shown) for providing the common code key (K0) transmitted from the transmission amplification unit (546) to the code key registration device. The herein-mentioned code key registration device, which is a PDA, a notebook or a remote controller intrinsically equipped with a wireless infrared communication device as mentioned before, reads out the common code key (K0) from the transmission port of the wireless communication port unit (541), or transmits the common code key (K0) to the reception port of the wireless communication port unit (541).

The reception filter unit (542) and the reception amplification unit (543) are reception data converters, where the reception filter unit (542) filters noise contained in the reception data signal including the common code key (K0) transmitted from the wireless communication port unit (541) for transmission to the reception amplification unit (543), while the reception amplification unit (543) amplifies the reception data signal filtered via the reception filter unit (542) to a predetermined amplification rate for transmission to the wireless data communication unit (544).

The transmission filter unit (545) and the transmission amplification unit (546) are transmission data converters, where the transmission filter unit (545) filters noise contained in the transmission data signal including the common code key (K0) transmitted from the wireless data communication unit (544) for transmission to the transmission amplification unit (546), while the transmission amplification unit (546) amplifies the transmission data signal filtered via the transmission filter unit (545) to a predetermined amplification rate for transmission to the wireless communication port unit (541).

The wireless data communication unit (544) demodulates the reception data signal transmitted from the reception amplification unit (543), i.e., an analog signal, to a digital signal for transmission to the central processing unit (520), or modulates the transmission data signal transmitted from the central processing unit (520), i.e., a digital signal, to an analog signal for transmission to the transmission filter unit (545).

Meanwhile, the central processing unit (520) stores in the data storage (530) the common code key (K0) transmitted from the reception port of the wireless data communication module unit (540), and provides the common code key (K0) stored in the data storage (530) to the code key registration device when there is a request for the common code key (K0). At this time, the common code key (K0) may be registered when the regional information control device (50) is made or installed.

The central processing unit (520) implements a verifying process with regard to the common code key registration device when there is a request for the common code key (K0) from the code key registration device. The verifying process is a process for determining whether the code key registration device is a proper device for being provided with the common code key (K0). For example, a prior established information with regard to a proper code key registration device is registered beforehand, and information of a code key registration device attempting a request is compared with the prior-established information to determine the proper code key registration device. Furthermore, a prior-established secret number is registered, and verification is allowed when a secret number identical to the prior-established secret number is inputted. If it is determined that a code key registration device attempting a request via the verification process is not a proper registration device, the central processing unit (520) does not provide the common code key (K0), or does not register the common code key (K0) inputted via the improper code key registration device.

Through this verification process, a communication device or an installation not verified by the proper method or process can be prevented from being illegally accessed to a subscriber network such that data outflow or manipulation such as information distortion or obtainment can be avoided.

In addition, the central processing unit (520) stores the reading data transmitted from the power line communication module unit (510) at the data storage (530), and extracts a related reading data out of a plurality of reading data stored at the data storage (530) in response to a request signal transmitted from the wireless communication module unit (550) to the data communication network (40) via the wireless communication module unit (550). Furthermore, the central processing unit (520) temporarily stores the service data transmitted from the wireless communication module unit (550) and transmits the service data to the power line communication module unit (510). Meanwhile, the data storage (530) includes the non-volatile memory devices such as Read Only Memory (ROM) and FLASH memory, and Random Access Memory (RAM). The data storage (530) is stored in real time with reading data transmitted from the central processing unit (520) on the monthly, weekly, nightly, daily and timely bases per dwelling (H1 to Hm). Furthermore, the data storage (530) is stored with the common code key (K0). Preferably, the common code key (K0) is stored at a ROM of non-volatile memory, such that even if there is an interruption of the power supply, the common code key (K0) can be maintained in the stored state at the data storage (530) without any problem. The RAM of the data storage (530) is stored with service data received from the wire data communication module unit (550) and provided via the central processing unit (520).

[Meter Gateways ]

Each meter gateway (M1 to Mm) is installed at a place of each dweller (H1 to Hm) where an existing meter is mounted. The meter gateways (M1 to Mm) conduct a power line communication with the regional information control device (50) via the outdoor incoming line (80). Furthermore, the meter gateways (M1 to Mm) perform a power line communication with residential home indoor information control devices (D1 to Dm) and the terminals (T1 to Tn) respectively installed at each dwelling (H1 to Hm) via the indoor incoming line (90).

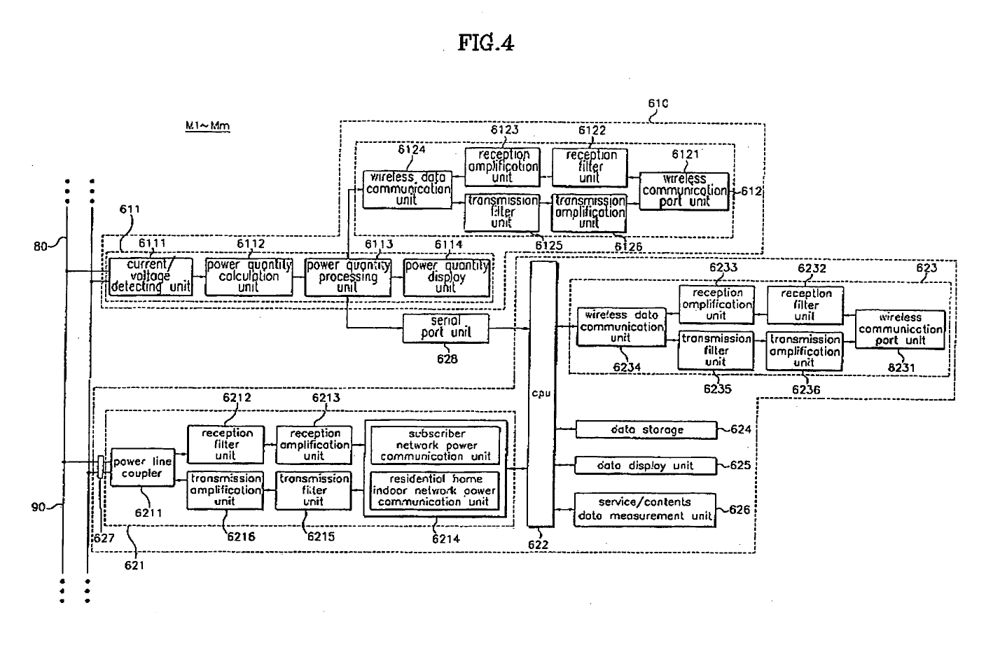

Furthermore, the meter gateways (M1 to Mm) receive the service data from the regional information control device (50) via the outdoor incoming line (80) and temporarily store the data in the data storage (see reference numeral 624 of FIG. 4). For example, a large capacity content data is temporarily stored. The service data thus stored in the data storage (624) are provided to the terminals (T1 to Tn) via the indoor incoming line (90) when a request is made.

Still furthermore, the meter gateways (M1 to Mm) measure intangible information such as service data and content data contained in the service data provided to each terminal (T1 to Tn). For example, the service measurement methods include a timely service measurement method, content service measurement method, and unit information and control service measurement method, detailed explanations of which will be given later.

The meter gateways (M1 to Mm) measure power meter readings of relevant dwellings (H1 to Hm) for supply to the regional information control device (50) via the outdoor incoming line (80). The meter gateways (M1 to Mm) receive the gas/piped water readings from the residential home indoor information control device (D1 to Dm) and provide the readings to the regional information control device (50) via the outdoor incoming line (80). The meter gateways (M1 to Mm) may directly receive the gas/piped water readings from the terminals (T1 to Tn).

The meter gateway (M1 to Mm) is allocated with the common code key (K0) and a private code key (K1 to Km) for storage at the data storage, and use the common code key (K0) to decode/encode the data when the data are transmitted to and received from the regional information control device (50). When the data are transmitted to and received from the residential home indoor information control devices (D1 to Dm) and the terminals (T1 to Tn), the residential home intrinsic code keys (K1 to Km) are used to decode/encode the data. It should be noted that the ‘KO’ and the ‘Km’ are different code keys.

Referring now to FIG. 4, the meter gateways (M1 to Mm) include a power measurer (610) and a service measurer (620). The power measurer (610) includes a power measurement module unit (611) and a wireless data communication module unit (612). The service measurer (620) includes a power line communication module unit (621), a central processing unit (622), a wireless data communication module unit (623), a data storage (624), a data display unit (625), a service/content data measurement unit (626) and an operation switch unit (627). The power measurer (610) is connected to the service measurer (620) via a serial port unit (628). The power measurer (610) measures the used power quantity in real time and transmits same to the central processing unit (622) of the service measurer (620) via the serial port unit (628).

The power measurement module unit (611) includes a current/voltage detection unit (6111), a power quantity calculation unit (6112), a power quantity processing unit (6113) and a power quantity display unit (6114). The current/voltage detection unit (6111) detects the current/voltage from the power source (alternating current power source) supplied to the related dwelling via the outdoor incoming line (80). The power quantity calculation unit (6112) uses the current/voltage detected by the current/voltage detection unit (6111) to calculate the power quantity. The power quantity processing unit (6113) provides the power quantity detected by the power quantity calculation unit (6112) to the power line communication module unit (621) via the serial port unit (628). The power quantity display unit (6114) displays in real time the power quantity provided from the power quantity processing unit (6113).

The wireless data communication module unit (612), which is a wireless infrared communication module unit, receives a control signal transmitted from an external infrared remote controller (not shown) and transmits same to the power quantity processing unit (6113) of the power measurement module unit (611). Additionally, the wireless data communication module unit (612) may provide the power quantity provided from the power measurement module unit (611) to an external infrared communication device (not shown). The external communication device may be a PDA, a notebook or the like capable of infrared communication.

The wireless data communication module unit (612) includes a wireless communication port unit (6121), a reception filter unit (6122), a reception amplification unit (6123), a wireless data communication unit (6124), a transmission filter unit (6125) and a transmission amplification unit (6126).

The wireless communication port unit (6121), which is a wireless infrared communication port unit, receives a control signal transmitted from the external infrared remote controller. The reception filter unit (6122) filters the control signal received from the wireless communication port unit (6121). The reception amplification unit (6123) amplifies the filtered control signal. The wireless data communication unit (6124) demodulates the amplified control signal for transmission to the power quantity processing unit (6113). The power quantity processing unit (6113) is controlled by the control signal thereof. Furthermore, the power quantity is provided to the outside via the wireless data communication unit (6124), the transmission filter unit (6125), the transmission amplification unit (6126) and the wireless communication port unit (6121) when there is a request of the power quantity.

The power measurer (610), although not shown, may further include a central processing unit, a data storage, a power line communication module unit and the like, and transmit the reading data to the regional information control device (50) via the outdoor incoming line (80), independently and separately from the service measurer (620). The herein-mentioned central processing unit, the data storage, the power line communication module unit may be formed in the same construction as the central processing unit (622), the data storage (624), the power line communication module unit (621) to be described in the service measurer (620). The power measurer (610) may be independently constructed from that of the service measurer (620) to thereby enable to provide convenient and simple management and operation to power company controllers and network providers.

The service measurer (620) first receives service data provided from the regional information control device (50) via the outdoor incoming line (80) and provides the service data to each terminal (T1 to Tn). The service measurer (620) further measures the intangible information such as service data and the like. The service measurer (620) is allocated with the common code key (K0) and the private code keys (K1 to Km), and when encoded data is transmitted from the regional information control device (50), the residential home indoor control device (D1 to Dm) or terminals (T1 to Tn), the common code key (K0) or the private code key (K1 to Km) are used to decode the encoded data. Furthermore, when the service measurer (620) intends to transmit data to the regional information control device (50), residential home indoor information control device (D1 to Dm) or terminals (T1 to Tn), the service measurement unit (620) uses the common key (K0) or private code key (K1 to Km) to encode the data and transmits the encoded data.

The power line communication module unit (621) detects a variety of data such as service data, reading data or Internet access data transmitted through the outdoor incoming line (80) or the indoor incoming line (90). The power line communication module unit (621) also sends various data such as the service reading data, reading data or the Internet access data to the outdoor incoming line (80), and also sends the service data to the indoor incoming line (90). The service reading data herein mentioned is a measured value of the service data.

The power line communication module unit (621) includes a power line coupler (6211), a reception filter unit (6212), a reception amplification unit (6213), a power line communication unit (6214), a transmission filter unit (6215) and a transmission amplification unit (6216). First, the data reception operation will be explained.

The power line coupler (6211) detects a variety of data from the outdoor incoming line (80) or the indoor incoming line (90) and transmits the data to the reception filter unit (6212), which in turn filters the data. The reception amplification unit (6213) transmits the data provided from the reception filter unit (6212) to the power line communication unit (6214). For example, the data detected from the outdoor incoming line (80) is provided to a subscriber network power communication unit, and the data detected from the indoor incoming line (90) is provided to a residential home indoor network power communication unit. The power line communication unit (6214) demodulates the data and transmits the data to the central processing unit (622). Next, the data transmission operation will be described.

The power line communication unit (6214) modulates the data transmitted from the central processing unit (622) and sends the modulated data to the transmission filter unit (6215), which in turn filters the data provided from the power line communication unit (6214). The transmission amplification unit (6216) provides the data provided from the transmission filter unit (6215) to the power line coupler (6211). The power line coupler (6211) sends the data provided from the transmission amplification unit (6216) to the outdoor incoming line (80) or to the indoor incoming line (90). The wireless data communication module unit (623) is a wireless infrared communication module unit just like the wireless data communication module unit (540) of the regional information control device (50). The wireless data communication module unit (623) receives the common code key (K0) and the private code key (K1 to Km) from a mobile code key registration device, and provides the registered common code key and private code keys (K1 to Km) to the mobile code key registration device. The wireless data communication module unit (623) includes a wireless communication port unit (6231), a reception filter unit (6232), a reception amplification unit (6233), a wireless data communication unit (6234), a transmission filter unit (6235) and a transmission amplification unit (6236).

The central processing unit (622) stores the common code key (K0) and the private code keys (K1 to Km) transmitted from a reception port of the wireless data communication module unit (623) in a ROM (Read Only Memory) of the data storage (624), and provides the common code key (K0) and the private code keys (K1 to Km) stored in the data storage (624) to the code key registration device via a transmission port of the wireless data communication module unit (6231) when a request is made.

The central processing unit (622) stores the power reading quantity provided from the serial port unit (628) and gas/piped water readings provided from the power line communication module unit (621) at the data storage (624). The central processing unit (622) further stores the service data provided from the power line communication module unit (621), particularly, a large capacity content data at the data storage (624) and displays the data at the data display unit (625).

The data storage (624) made of ROM and RAM is stored in real time with reading data transmitted from the central processing unit (622) in monthly, weekly, nightly, daily and timely bases per dwelling (H1 to Hm). The data storage (624) is stored with the common code keys (K0) and one of the private code keys (K1 to Km). The data storage (624) is further stored with the service data, particularly, a large capacity content data provided from the central processing unit (622). The data storage (624) is still further stored with service data readings calculated by the service/content data measurement unit (626).

The service/content data measurement unit (626) receives the service data and calculates the service/content readings included in the service data. As mentioned above, the service measurement methods include timely service measurement method, content service measurement method, and unit information and control service measurement method. This is because the service data is largely classified into time-related service, content-type service and unit information and control-type service.

The time-related service refers to a type of service in which service-provided time is calculated and a charge is levied thereto accordingly. Contents and information-type service largely refer to a type of service in which information and content readings provided from an external service provider are calculated and a charge is levied thereto accordingly. The content-type service herein mentioned largely means stream-type content service while the information-type service means a service providing relatively small capacity information including mails, text messages, traffic/weather information and the like. The control-type service represents a type of service in which a charge is levied when one time control service such as a remotely-controlled door service, illumination and electric home appliance control service or the like is requested.

A service-provided time is regarded as the most important calculating index for the time-related service measurement method compared to other services. Information necessary for measuring the time-related service includes service classification code, service request time, service requester information and service start time and the like with regard to service commencement, and includes service classification code, service completion request time, service requester information and service completion time and the like with regard to service completion. Furthermore, information necessary for time-related service measurement once the service is commenced includes information of major events occurring in the midst of service being performed, service performing time per service class (continuously upgraded at every predetermined time) and the like.

In particular, large capacity information frequently occurs in the process of the time-related service. For example, when an intrusion into a dwelling happens to trigger a residential home indoor monitoring camera (IP camera) installed in a residence and photographs the triggered scene, the large capacity image information is generated.

The meter gateways (M1 to Mm) collect said image information to allow the data storage (624) to store the most updated information for the time being, and the prior image information is temporarily stored in the residential home indoor information control device (D1 to Dm) or in the regional information control device (50). When the above-mentioned image information is to be publicly read from the outside, it is necessary to obtain a subscriber approval. For protection of subscriber information, image information stored in the regional information control device (50) is encoded by way of the common code key (K0), thereby enabling to protect privacy. The amount of service information and type of information are important measurement indexes for the content-type service measurement method. For that reason, information necessary for the content-type service measurement includes a service classification code, content service priority classification code, service request time, service requester information and the like with regard to service commencement. The content service priority classification code, which is a code for representing a priority of charges for provided contents, is provided to each content by content provider servers, and is provided to a subscriber beforehand when the subscriber requests the contents via the residential home indoor information control device (D1 to Dm). Information to be controlled upon commencement of the service is a total information quantity (Mbyte unit) covering the major information occurring while the service is performed and information-type service.

The frequency of information requests, rather than the provided information quantity or time, is the important measurement index for the unit information and control-type service measurement method. For that reason, information necessary for measurement of unit information and control-type service includes a service classification code, service request time, service requester information and the like. Furthermore, the unit information and control-type service, as mentioned before, includes relatively small capacity information including mails, text messages, traffic/weather information and the like, and remote control of illumination/door/home electric appliances.

Hereinafter, the time-related service measurement method among the many above-mentioned service measurement methods will be explained.

For example, a subscriber requests a time-related service commencement via the residential home indoor information control device (D1 to Dm) in case the subscriber is inside the residential home. Meanwhile, in case he or she is outside of the residential home, the subscriber may use a data communication network or Internet network for requesting the time-related service from a far-away location.

Meanwhile, the meter gateways (M1 to Mm) is provided with a time-related service request signal provided from the residential home indoor information control device (D1 to Dm), and detects a service classification code, service request time and service commencement requester (subscriber) information with regard to the service requested by the subscriber and stores the information at the data storage (624).

Furthermore, the meter gateways (M1 to Mm) provide the service request signal of the subscriber to the service provider server (30) via the regional information control device (50). The service provider server (30) transmits a related service data in response to the service request signal to the meter gateways (M1 to Mm) via the regional information control device (50). The meter gateways (M1 to Mm) receive the service data and detect a transmission time of the service data and store the time at the data storage (624).

Successively, when the subscriber requests the end of the time-related service via the residential home information control device (D1 to Dm), the meter gateways (M1 to Mm) is provided with the service completion request signal, and detects the service classification code, service completion request time and service requester information with regard to the service requesting the end of the service for storing at the data storage (624). The service provider server (30) ends transmission of the service data in response to the service completion request signal.

Meanwhile, the service/content data measurement unit (626) of the meter gateways (M1 to Mm) calculates the time-related service quantity used, based on the service classification code, service request time and service commencement requester information stored in the data storage (624) at the request of the service commencement, service classification code, service completion request time and service completion requester information at the request of service completion.

The service/content data measurement unit (626) considers, at the time of time-related service measurement, a separate major event information generated after service commencement and the service implementation time per service to calculate the service quantity used.

The data display unit (625) displays information (including the service rate information) of a service desired to be requested by the subscriber or information of a service being requested, and other variety of service data are displayed thereon. For example, the data display unit (625) may be an ElectroLuminiscent Display or a Liquid Crystal Display.

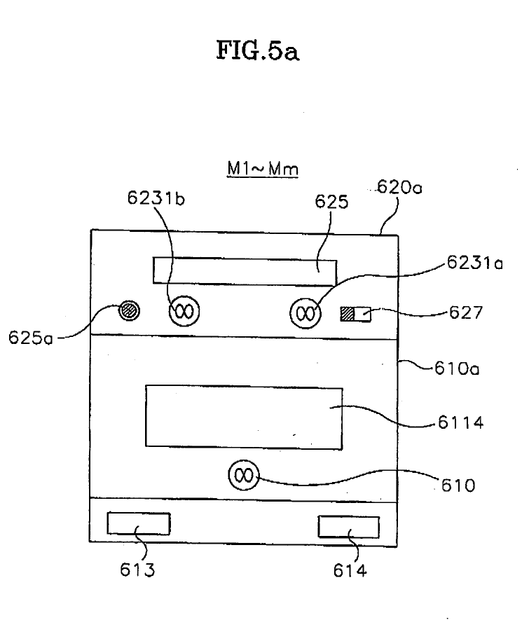

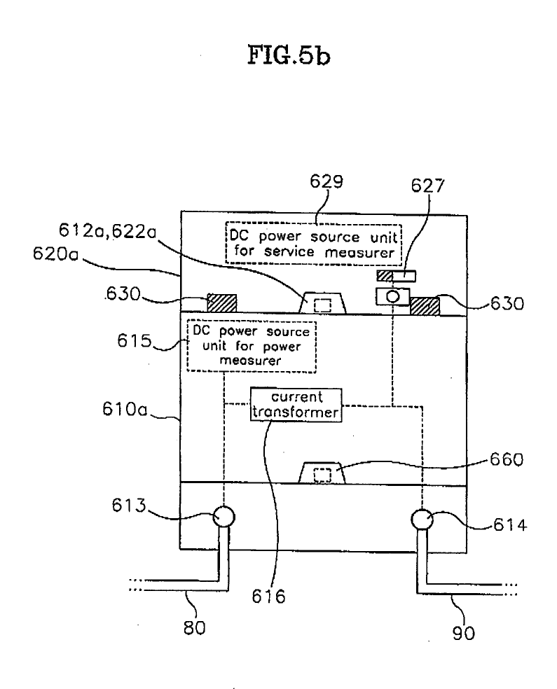

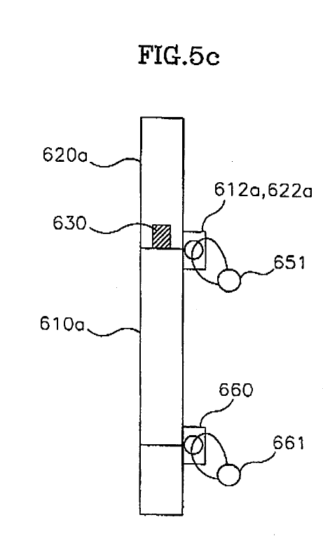

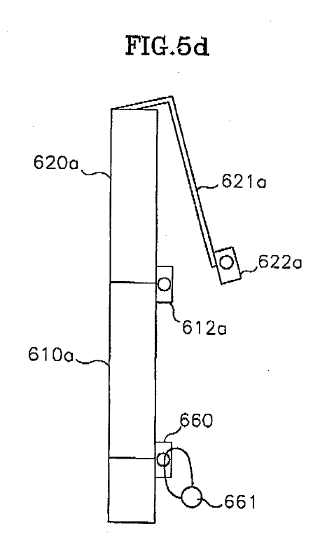

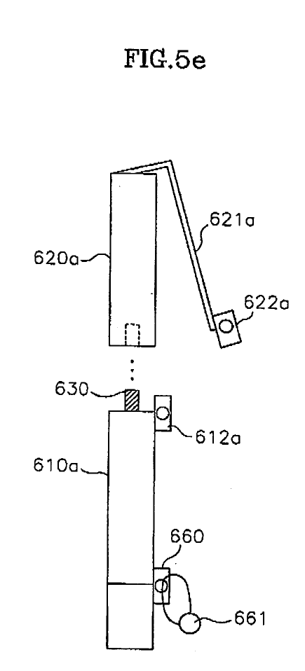

FIGS. 5a to 5e illustrate external views of a casing of the meter gateways (M1 to Mm) shown in FIG. 4, where FIG. 5a is a front view, FIG. 5b is an inner prospective view, FIGS.

5c and 5d are side views and FIG. 5E is an exploded view.

Referring now to FIGS. 5a to 5e, the supplemental service meter gateway (M1 to Mm) according the preferred embodiment of the present invention includes a service 30 measurer (620) and a power measurer (610). The service measurer (620) and the power measurer (610) are separate devices but attachably and detachably coupled therebetween via a support unit as shown in FIG. 5e.

The service measurer (620) and the power measurer (610) are respectively inserted into square casings (620a, 610a) each in the shape of a board. Hereinafter, the casing (620a) is referred to as a service measurer casing and the other casing (610a) is referred to as a power measurer casing.

The service measurer casing (620a) is disposed thereunder with a support groove (not shown) into which two support members (630) disposed at an upper end of the power measurer casing (610a) are inserted to allow the service measurer casing (620a) to be supported to the power measurer casing (610a).

Furthermore, the service measurer casing (620a) is coupled by a coupling member. The coupling member includes an upper side member (622a) disposed at a distal end of a cover (621a) of the service measurer casing (620a), and a lower side member (612a) disposed at a front upper side of the power measurer casing (610a). The two members (612a, 622a) are locked by a sealing member (651). The power measurer casing (610a) is made to be locked by a sealing member (661) that is sealed by a power company administrator, and is also mounted with a coupling member (660) having the same structure as that of the coupling member comprised of the upper and lower side members (612a, 622a).

Referring now to FIG. 5a, the service measurer casing (620a) is positioned with a data display unit (625) illustrated in FIG. 4, transceiver ports (6231a, 6231b) of the wireless communication port unit (6231), a Light Emitting Diode (LED) display unit (625a), and an operation switch unit (627).

As mentioned before, the data display unit (625) displays information of a service a subscriber desires to request, or information of a service under request (including service rate information). A reception port (6231a) for registering the common code key (K0) and the private code keys (K1 to Km) is a port for receiving an external control signal. The transmission port (6231b) is a port for sending the common code key (K0) and the private code keys (K1 to Km) to an external code key registration device. The LED display unit (625a) serves to display a progressing stage of the service data.

Meanwhile, the LED display unit (625a) displays the presence and absence of the service provided to a subscriber receives via ON/OFF, where a provided service rate is high when a flickering speed is fast, while the service rate is low when the flickering speed is slow. The operation switch unit (627) of a power source switch is interposed between the power line communication module unit (621) and the outdoor incoming line (80), and controls the Alternating Current (AC) power source supplied to the service measurer (620) for overall control of the operation.

Meanwhile, as shown in FIG. 5b, the outdoor incoming line (80) is connected to an input terminal (613) mounted underneath the power measurer casing (610a) to be connected to a Direct Current (DC) power source unit for a power measurer (615). The AC power source supplied to the outdoor incoming line (80) is converted to a DC current by the DC power source unit for power measurer (615) to be supplied to the power measurer (610). The AC power source supplied to an input terminal (613) via the outdoor incoming line (80) is supplied to the indoor incoming line (90) via a Current Transformer (CT, 616) through an output terminal (614). The AC power source outputted to the CT is supplied to a DC power source unit for a service measurer (629) via a service measurer side terminal. The DC power source unit for the service measurer (629) converts an AC power source to a DC power source for supply to the service measurer (620). Between the service measurer side terminal and the DC power source unit for the service measurer (629) there is disposed the operation switch unit (627) for controlling the supply of power source to the service measurer side, such that the overall operation of the service measurer (620) is controlled.

As mentioned in the above description, the meter gateways (M1 to Mn) are separately equipped with a service measuring function and a power measuring function, such that an energy measurer of power and a service measurer respectively take charge of independent measuring functions. In order to warrant an independent operation of control and administration for the power measurer (610) and the service measurer (620), the power measurer (610) and the service measurer (620) are independently sealed by separate sealing members (651, 661), whereby it is possible for the power provider and the network provider to control the power measurer (610) and the service measurer (620) independently.

When a network provider intends to maintain and/or repair the service measurer (620), the only thing to do is for the sealing member (651) of the network control company to unseal and open a cover (621a) as illustrated in FIG. 5d.

As described in the foregoing, the DC power source unit for the service measurer (629) utilizes the AC power source of the output side (load side) and the operation switch unit (627) is arranged to prompt a network control company to turn on or turn off the power source supply. In other words, when a subscriber applies for a service, the network provider unseals the sealing member (651) of the service measurer (620), and the cover (621a) of the service measurer (620) is opened to turn on the power of the service measurer (620), and closes the cover (621a) to seal by utilizing the sealing member (651) of the service measurer (620).

For reference, as mentioned above, the meter gateways (M1 to Mm) independently operate the service measurer (620). As a result, the power quantity consumed for driving the service measurer (620) should be paid accordingly. In this case, the power measurer (610) is so constructed as to simultaneously read the power readings used by the service measurer (620), and charges for the power readings used for driving the service measurer (620) should be borne by the network provider.

[Residential Home Indoor Information Control Device]

The residential home indoor information control device (D1 to Dm) is one of the residential home indoor information devices installed in every dwelling (H1 to Hm), and is connected to the meter gateways (M1 to Mm) via the indoor incoming line (90) to conduct the power line communication. In other words, the residential home indoor information control device (D1 to Dm) is a user terminal equipped with a man-machine-interface unit, i.e., a control input unit (750) shown in FIG. 6, so that a subscriber can request the service of receiving information, contents and the like.

Furthermore, the residential home indoor information control device (D1 to Dm) forms a residential home indoor network via the meter gateways (M1 to Mm), the terminals (T1 to Tn) and the indoor incoming line (90). Each residential home indoor network shares one identical private code key to commonly conduct the data encoding/decoding. For example, the residential home indoor information control device (D1) shares a private code key (K1) with the meter gateway (M1) and terminals (T1 to Tn) to conduct the data encoding/decoding.

Referring to FIG. 6, the residential home indoor information control device (D1 to Dm) includes a power line communication module unit (710), a central processing unit (720), a data storage (730), a data display unit (740), a control input unit (750), a wireless data communication module unit (760), a wire data communication module unit (770) and a code key registration commencement unit (780).

The power line communication module unit (710) detects various data including service data, reading data or Internet access data transmitted via the outdoor power line (90). Furthermore, the power line communication unit (710) transmits various data including the reading data, service reading data or Internet access data via the indoor incoming line (90).

The power line communication module unit (710), just like the power line communication module unit (621) of the meter gateways (M1 to Mm) of FIG. 4, includes a power line coupler (711), a reception filter unit (712), a reception amplification unit (713), a power line communication unit (714), a transmission filter unit (715) and a transmission amplification unit (716).

The wireless data communication module unit (760) is a wireless infrared communication module unit, and is provided with a related private code key out of the private code keys (K1 to Km) from the mobile code key registration unit.

As described above, the mobile code key registration device may be a PDA, a notebook or a remote controller installed therein with a wireless infrared communication device.

The wireless data communication module unit (760), just like the wireless data communication module unit (623) of the meter gateways (M1 to Mm) of FIG. 4, includes a wireless communication port unit (761), a reception filter unit (762), a reception amplification unit (763), a wireless data communication unit (764), a transmission filter unit (765), and a transmission amplification unit (766). The wireless data communication module unit (760) may also conduct a wireless data communication with a terminal which performs the wireless data communication out of the terminals (T1 to Tn).

The wire data communication module unit (770) is a module for transmission and reception of data via a separate communication line with a terminal for conducting data communication out of the terminals (T1 to Tn) such as a computer, a VoIP (Voice over Internet Protocol) phone, IP (Internet Protocol) camera or a security administration control device (not shown). The wire data communication module unit (770) includes a wire communication port unit (771, for example, RJ45, USB), a reception filter unit (772), a reception amplification unit (773), a wire data communication unit (774), a transmission filter unit (775) and a transmission amplification unit (776). If it is possible to conduct a high-speed power line communication with the terminals (T1 to Tn) via the indoor incoming line (90), the wire data communication module unit (770) may not be installed.

The central processing unit (720) stores at a ROM of the data storage (730) one of the private code keys (K1 to Km) transmitted from a reception port of the wireless data communication module unit (760). Data communication is conducted with a related meter gateway out of meter gateways (M1 to Mm) and the terminals (T1 to Tn) by using the private code key stored in the data storage (730).

The central processing unit (720) stores the gas/piped water readings provided from the power line communication module unit (710) at the data storage (730), and when a request is made, the gas/piped water readings are transmitted to the relevant meter gateway. The central processing unit (720) stores the service data, particularly, large capacity content data provided from the power line communication module unit (710) at the data storage (730) and transmits same to the terminals (T1 to Tn) when there is a request. The service data thus mentioned is displayed on the data display unit (740).

The data storage (730) made of ROM and RAM is stored in real time with gas/piped water readings transmitted from the central processing unit (720) in monthly, weekly, nightly, daily and timely bases. The data storage (730) is stored with the private code key. The data storage (730) is further stored with service data, particularly, large capacity content data provided from the central processing unit (720).

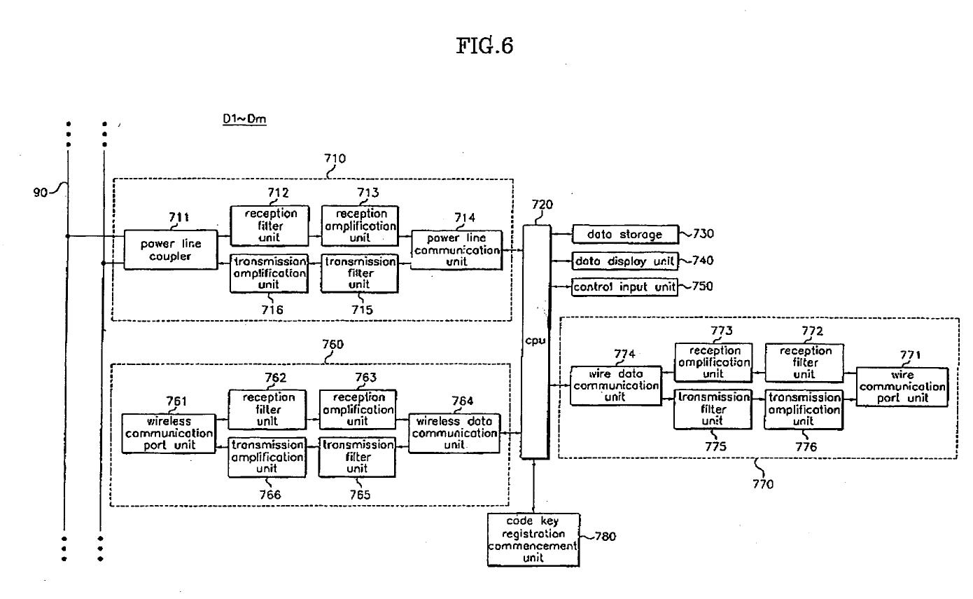

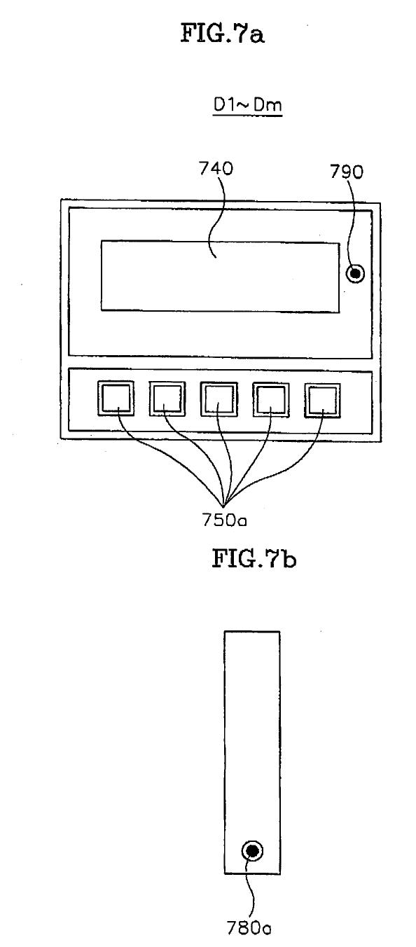

The control input unit (750) provides an Interface between the subscribers and the residential home indoor information control devices (D1 to Dm) so that the subscribers can request service via the residential home indoor information control devices (D1 to Dm). A subscriber manipulates a subscriber manipulation button unit (750a) of FIG. 7a to request the service data, i.e., services such as the service/content and the like.

The code key registration commencement unit (780) converts a state of the residential home indoor information control device (D1 to Dm) to a stand-by mode for registration of the private code keys (K1 to Km) in the residential home indoor control devices (D1 to Dm). A subscriber approaches a remote controller (100) which is a code key registration device to the wireless communication port unit (761) at the residential home indoor information control devices (D1 to Dm) and pushes a code key registration commencement pin (reference numeral 780a of FIG. 7b) installed at the residential home indoor information control devices (D1 to Dm). The residential home indoor control devices (D1 to Dm) now gets ready for storage of the private code keys (K1 to Km). Meanwhile, FIG. 7b is a side view of the residential home indoor information control devices (D1 to Dm).

The data display unit (740) displays information of a service for a subscriber to be provided with, or information of a service under request (including service rate information). The data display unit (740) also displays various other service data.

Referring now to FIG. 7a, the LED display unit (790) is disposed at a side of the data display unit (740) to display the presence and absence of services provided to a subscriber is provided with as ON/OFF, where a provided service rate is high when a flickering speed is fast, while the service rate is low when the flickering speed is slow.

[Terminals]

The terminals (T1 to Tn) include a gas/piped water meter inherently equipped with a power line communication module, a sensor, actuator, electric home appliances, wirings (outlets), light, personal computer (PC), VoIP (Voice over Internet Protocol) phone, IP camera, security device and the like inherently equipped with a power line communication modem, for the high-speed power line communication with the residential home indoor information control devices (D1 to Dm) and meter gateways (M1 to Mm) via the indoor incoming line (80).

For example, the electric home appliances may include air conditioners, refrigerators, interactive TV, audio equipment and the like. As mentioned above, the terminals (T1 to Tn) conduct the power line communication with the residential home indoor information control devices (D1 to Dm) and the meter gateways (M1 to Mm) via the power line communication module or power line communication modem.

The terminals (T1 to Tn) share the same private code key with the meter gateways (M1 to Mm) and the terminals (T1 to Tn), just like the residential home indoor information control devices (D1 to Dm), to commonly conduct the data encoding/decoding.

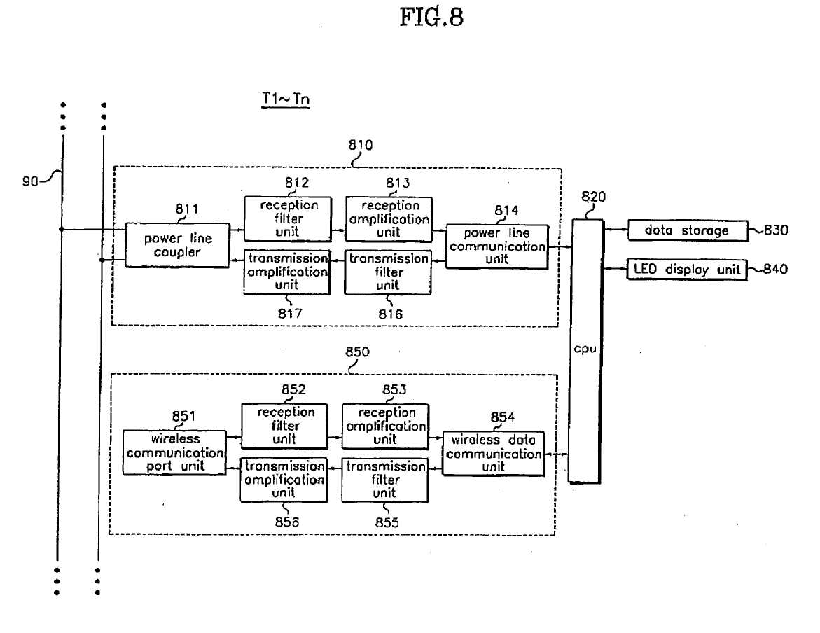

For example, as shown in FIG. 8, the terminals (T1 to Tn) include a power line communication module unit (810), a central processing unit (820) and a data storage (830), a LED display unit (840) and a wireless data communication module unit (850). The terminals (T1 to Tn) illustrated in FIG. 8 are component parts commonly required for all the terminals (T1 to Tn) regardless of the kinds of terminals for conducting the power line communication.

The power line communication module unit (810) detects a variety of data including service data, control signals or Internet access data transmitted via the indoor incoming line (90), and transmits various data including reading data, service request signals via the indoor incoming line (90). The power line communication module unit (810) includes a power line coupler (811), a reception filter unit (812), a reception amplification unit (813), a power line communication unit (814), a transmission filter unit (816) and a transmission amplification unit (817).

The wireless data communication module unit (850), which is a wireless infrared communication module unit, receives from the mobile code key registration device a relevant private code key out of private code keys (K1 to Km). The mobile code key registration device may be a PDA, a notebook or a remote controller intrinsically mounted with a wireless infrared communication device, as mentioned in the above description.

The wireless data communication module unit (850) includes a wireless communication port unit (851), a reception filter unit (852), a reception amplification unit (853), a wireless data communication unit (854), a transmission filter unit (855), and a transmission amplification unit (856). The wireless data communication module unit (850) may separately conduct a wireless communication with a wireless communication device used by a subscriber. In other words, the wireless data communication module unit (850) provides a wireless interface between subscribers and the terminals (T1 to TN).

The central processing unit (820) stores at a ROM of the data storage (830) one of the private code keys (K1 to Km) transmitted from a reception port of the wireless data communication module unit (850). Data communication is conducted with a related meter gateway out of meter gateways (M1 to Mm) and the terminals (T1 to Tn) by using the private code key stored in the data storage (830).

The central processing unit (820) stores the service data provided from the power line communication module unit (810) at the data storage (830), or transmits to a relevant communication device such as a computer, a VoIP phone, an IP camera or a security device. Furthermore, the central processing unit (820) also stores the gas/piped water readings inspected by a gas/piped water meter at the data storage (830).

The data storage (830) made of ROM and RAM is stored in real time with the gas/piped water readings transmitted from the central processing unit (820) in monthly, weekly, nightly, daily and timely bases. The data storage (830) is also stored with a private code key. The data storage (830) may further be stored with service data, particularly, large capacity content data provided from the central processing unit (820).

The LED display unit (840) displays the presence and absence of services provided to a subscriber is provided with as ON/OFF, where a provided service rate is high when a flickering speed is fast, while the service rate is low when the flickering speed is slow.

Meanwhile, the mobile code key registration device will be described in detail with reference to FIGS. 9 and 10, where FIG. 9 is a block diagram of a remote controller in the mobile code key registration device and FIG. 10 is an outside view of the remote controller illustrated in FIG. 9.

Referring to FIG. 9, the remote controller (100) includes a wireless data communication module unit (110), a central processing unit (120), a data storage (130), a data display unit (140), a state display unit (150), an operation control input unit (160) and a power source (170).

The wireless data communication module unit (110), which is a wireless infrared communication module unit, conducts a wireless infrared communication with the wireless data communication module unit (540) of the regional information control device (50) illustrated in FIG. 3, or the wireless data communication module unit (623) of the meter gateways (M1 to Mm) illustrated in FIG. 4, or the wireless data communication module unit (850) of the terminals (T1 to Tn) illustrated in FIG. 8. The wireless data communication module unit (110) includes a wireless communication port unit (111), a reception filter unit (112), a reception amplification unit (113), a wireless data communication unit (114), a transmission filter unit (115), and a transmission amplification unit (116).

The central processing unit (120) fetches the common code key (K0) and/or private code key (K1 to Km) stored at the ROM of non-volatile memory of the data storage (130) according to the control of the operation control input unit (160), and stores the common code key (K0) and/or private code keys (K1 to Km) provided from the wireless data communication module unit (110) at the ROM of the data storage (130).

Furthermore, the central processing unit (120) displays the write (W) or read (R) process of the common code key (K0) and/or private code key (K1 to Km) on the state display unit (150). The central processing unit (120) may also display the write or read process on the data display unit (140).

The data storage (130) is made of ROM and RAM, and the ROM is stored with the common code key (K0) and/or private code keys (K1 to Km) during or after manufacturing of the remote controller (100). For example, when a common code key (K0) and a private code key (KI) are to be registered with the meter gateway (Ml), the data storage (130) of the remote controller (100) provided to the subscriber is stored with the common code key (K0) and the private code key (K1). Meanwhile, when the regional information control device (50) is to be registered with the common code key (K0), the data storage (130) of the remote controller (100) is stored with the common code key (K0).

Referring now to FIG. 10, the state display unit (150) composed of at least one LED displays the write process or the read process of the common code key (K0) and/or private code keys (K1 to Km). For example, when the write process or the read process fails, a red light is illuminated, and when the write or read process succeeds, the green light is illuminated.

The operation control input unit (160) is comprised of a code key write control unit (161) and a code key read control unit (162). The code key write control unit (161) controls the central processing unit (120) to write the common code key (K0) and/or private code keys (K1 to Km) onto the meter gateways (M1 to Mn), the regional information control device (50), the residential home indoor information control device (D1 to Dm) or the terminals (T1 to Tn) via the wireless data communication module unit (110). The code key read control unit (162) controls the central processing unit (120) to read out the common code key (K0) and/or the private code keys (K1 to Km) from the meter gateways (M1 to Mm) via the wireless data communication module unit (110).

Referring now to FIG. 10, the remote controller (100) is equipped at the front thereof with a code key write button (161a) and a code key read button (162a). For example, a subscriber approaches the wireless communication port unit (111) of the remote controller (100) to the wireless communication port unit (6231) of the meter gateways (M1 to Mm) to push the code key read button (162a) and to download the common code key (K0) and/or the private code keys (K1 to Km) stored at the data storage (624) of the meter gateways (M1 to Mm). When the common code key (K0) and the private code keys (K1 to Km) are normally downloaded and stored at the data storage (130), the LED (150) illuminates a green light. Otherwise, the LED illuminates a red light.

Meanwhile, as mentioned in the foregoing, the registration process of the common code key (K0) with the regional information control device (50) should be implemented. Hereinafter, a registration process of the common code key (K0) using the remote controller (100) will be described.

First, an explanation will be given for a case where the common code key (K0) is stored at the data storage (624) of the meter gateways (M1 to MM).

A network provider uses the remote controller (100) to read out the common code key (K0) stored at the data storage (624) of the meter gateways (M1 to Mm). In other words, the wireless communication port unit (111) of the remote controller (100) approaches the transmission port unit (6231b) of the wireless communication port unit (6231) at the meter gateways (M1 to Mm) to read out the common code key (K0) previously stored at the data storage (624). The common code keys (K0) thus read out is stored at the data storage (130) of the remote controller (100). Successively, the remote controller (100) approaches the wireless communication port unit (531) of the regional information control device (50) to prompt the common code key (K0) stored at the data storage (130) to be transmitted to the regional information control device (50). The common code key (K0) thus transmitted to the regional information control device (50) is stored at the data storage (530).

In another method, as mentioned before, the common code key (K0) is generated from the regional information control device (50) for storage at the data storage (530), instead of registering the common code key (K0) beforehand when the meter gateways (M1 to Mm) are manufactured for marketing. The common code key (K0) may be provided via a wireless communication or a wire communication instead of the above-mentioned generation method. At this time, registration of the common code key (K0) with the regional information control device (50) is possible only by an authorized user or administrator. In other words, it is also possible to remotely register a secret number of the regional information control device (50) from an administrative center.

Successively, the wireless communication port unit (111) of the remote controller (100) approaches a transmission port of the wireless communication port unit (541) of the regional information control device (50) to read out the common code key (K0) previously stored at the data storage (530). The common code key (K0) thus read out is stored at the data storage (130) of the remote controller (100). Next, the remote controller (100) approaches the reception port unit (6231a) of the meter gateways (M1 to Mm) to prompt the common code key (K0) stored at the data storage (130) to be transmitted to the meter gateways (M1 to Mm). The common code key (K0) transmitted to the meter gateways (M1 to Mm) is stored at the data storage (624) of the meter gateways (M1 to Mm).

Meanwhile, the registration process of the private code keys (K1 to Km) at the residential home indoor information control device (D1 to Dm) and the terminals (T1 to Tn) is the same as that of the afore-mentioned method. In other words, the remote controller is used to fetch the private code keys (K1 to Km) from the meter gateways (M1 to Mm) for storing same at the respective data storages (730, 830) of the residential home indoor information control device (D1 to Dm) and the terminals (T1 to Tn).

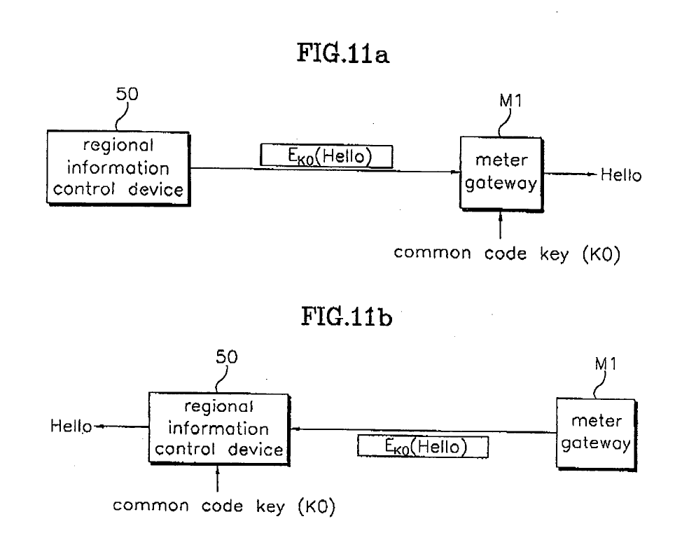

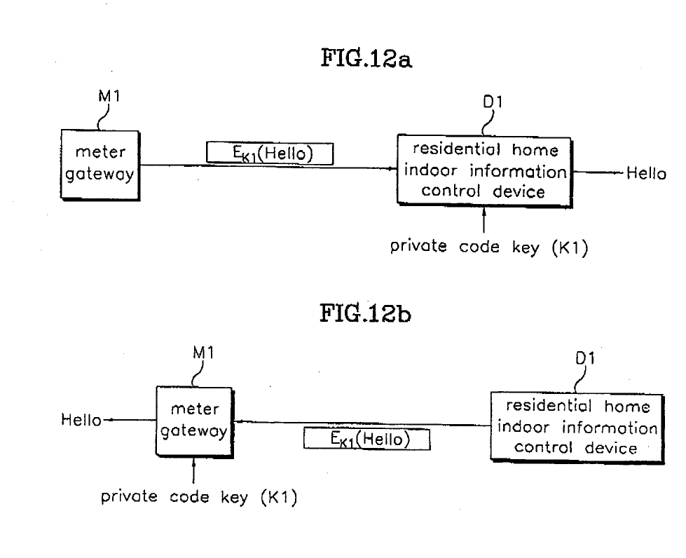

The preferred embodiment of the present invention will now be described with reference to FIGS. 11a, 11b, 12a and 12b. In the present embodiment, only the data transmission and reception between the regional information control device (50) and the meter gateway (M1), and data transmission and reception between the meter gateway (M1) and the residential home indoor information control device (D1) will be described for convenience sake.

Referring to FIG. 11a, when a message is transmitted from the regional information control device (50) to the meter gateway (M1), the regional information control device (50) uses the common code key (K0) to encode the message, and transmits the encoded message {EK0 (Hello)} to the meter gateway (M1). At this time, the encoded message {EK0 (Hello)} is provided to the meter gateway (M1) via the outdoor incoming line (80). The meter gateway (M1) detects the encoded message {EK0 (Hello)} and decodes the same using the common code key (K0) to obtain a decoded message (Hello).

Referring now to FIG. 11B, when the message (Hello) is to be transmitted from the meter gateway (M1) to a regional information control device (50) mutually verified with the meter gateway (M1), the meter gateway (M1) uses the common code key (K0) to encode the message (Hello) and to provide the encoded message to the regional information control device (50) via the outdoor incoming line (80). The regional information control device (50) receives the encoded message {EK0 (Hello)}, and then uses the common code key (K0) to decode the encoded message {EK0 (Hello)}, whereby the decoded message (Hello) can be obtained.

Meanwhile, as shown in FIGS. 12a and 12b, the data transmission and reception between the meter gateway (M1) and the residential home indoor control device (D1) is conducted in the same way as per the previous method. For example, the meter gateway (M1) and the residential home indoor information control device (D1) utilize the commonly-used private code key (K1 ) to implement the encoding and decoding.

In other words, data encoding and decoding are implemented by using the commonly-used identical private code key between the meter gateway and the residential home indoor information control device jointly connected by the residential home indoor network and the terminal

The foregoing description of the preferred embodiments of the present invention has been presented for the purpose of illustration and description. It is not intended to be exhaustive or to limit the invention to the precise form disclosed, and modifications and variations are possible in light of the above teachings or may be acquired from practice of the invention. It is intended that the scope of the invention be defined by the claims appended hereto, and their equivalents.

As apparent from the foregoing, there is an advantage in that value-added services are provided in addition to remote meter readings based on power line communication network, and power inspection for remote readings and service measurements responsive to the value-added services can be respectively and independently implemented.

There is another advantage in that value-added service function can be independently operated based on the power inspection and interactive data communication, such that, while functions of power metering and interactive data communication are maintained, value-added service measurements are so made as to be functionally and physically independent to thereby allow the power measurement function and the service measurement function to be independently controlled by a single meter gateway, whereby a power company administrator and network provider are provided with a simple and convenient control and operation thereof.

There is still another advantage in that the value-added service inspection method for reading the added value service based on the type of service/content, time of use, service download frequency, unit information and control-type service and the like can be provided using the service added meter gateways, whereby the effective service inspection can be performed.

There is still a further advantage in that remote readings, value-added service provision and value-added service readings can be stably provided by using supplementary service meter gateways, and power line communication system and method for stably implementing the data usage verification, data security and data control can be provided, resulting in new business opportunities for the power company in the process of uniting the power industries, communications and services.

There is still a further advantage in that low-cost and high quality services can be provided to consumers through mutual competition between existing communication provider-based network and service industries and power provider-based network and services. Also, equipment, service and content industries can be markedly activated including the effect of broadening the freedom of selection between the telephone networks and the power line communications on the parts of relevant equipment and service providing companies.

1. A supplemental service meter gateway comprising:
a power measurer for implementing a high-speed power line communication with a regional information control device via subscriber networks, implementing a high-speed power line communication with terminals of dwellings via residential home indoor networks, and reading the accumulated power of the dwellings from the residential home indoor networks to provide the reading data to the regional information control device via the subscriber networks; and
a service measurer for providing to the terminals service data supplied from the regional information control device via the subscriber networks in response to a request signal from the terminals and measuring the service data based on type of service/content, used service time, service/content download frequency, content information quantity, unit information, and control service providing frequency to transmit the measured service reading data to the regional information control device.

2. The gateway as defined in claim 1, wherein the service measurer detects a first data related to service commencement including service classification code, service request time, service requester information and service commencement time when the service data requested by the terminal relates to a time-related service, and detects a second data related to service completion including service classification code, service completion request time, service requester information and service completion time, and comparatively analyzes the first and second data for measurement of the service data.

3. The gateway as defined in claim 1, wherein the service measurer detects data related to service commencement including service classification code, content service priority classification code, service request time and service requester information when the service data requested by the terminal relates to the content-type service, to measure the service data in response to the content service priority classification code.

4. The gateway as defined in claim 1, wherein the service measurer detects the service classification code, service request time and service requester information when the service data requested by the terminal relates to the unit information and control-type service, and measures the service data in response to the frequency of the information request.

5. The gateway as defined in claim 1, comprises a DC power source unit for converting an alternating current voltage supplied via an outdoor incoming line constituting the subscriber network to a direct current voltage for use as an operating power source, independently from the power measurer.

6. The gateway as defined in claim 1, wherein the service measurer is intrinsically mounted in a board shape inside a service measurer casing disposed at an upper end of a power measurer casing via a support member so as to be attachably and detachably mounted with the power measurer casing in which the power measurer is intrinsically mounted in a board shape.

7. The gateway as defined in claim 6, wherein the service measurer casing is frontally equipped with a cover coupled by a sealing member for maintaining a sealing state and for protecting the service measurer.

8. The gateway as defined in claim 6, wherein the service measurer casing is frontally equipped with an operation switch for turning on and off the power source of the service measurer in response to a subscriber's manipulation.

9. The gateway as defined in claim 6, wherein the service measurer casing is frontally provided with a light emitting diode display unit for displaying a service state of the service data.

10. The gateway as defined in claim 9, wherein the light emitting diode display unit maintains an ON state when the service data is in service, and maintains an OFF state when the service data is not in service, and operates in various flickering speeds according to the service data in service mode.

11. The gateway as defined in claim 1, wherein the service measurer uses a common code key shared by the regional information control device to implement the data transmission and reception with the regional information control device.

12. The gateway as defined in claim 1, wherein the service measurer uses a private code key shared by each terminal of relevant dwellings to implement the data transmission and reception with the terminals.

13. The gateway as defined in claim 1, wherein the service measurer comprises:
a power line communication module unit for detecting the service data or Internet access data transmitted through the subscriber network, residential home indoor network, and transmitting the service reading data or the Internet access data to the subscriber network;
a wireless data communication module unit for receiving, from an external code key registration device capable of wireless infrared communication, a common code key shared by the regional information control device and a private code key shared by each terminal of relevant dwellings, or for providing the common code key and the private code key to the code key registration device when there is a request from the code key registration device;
a central processing unit for using the common code key transmitted from the wireless data communication module unit to decode the encoded data of the regional information control device provided via the subscriber network, or encoding the data to be provided to the regional information control device via the subscriber network, and using the private code key transmitted from the wireless data communication module unit to decode the encoded data of the terminal provided via the residential home indoor network, or encoding the data to be provided to the terminal via the residential home indoor network;
a data storage comprising a non-volatile memory which stores the common code key and the private code key received via the wireless data communication module unit, and temporarily stores the reading data and the service data detected via the power line communication module unit;
a data display unit for displaying in real time the transmitted and received states of the service data; and
a service/content data measurement unit for being provided with the service data detected via the power line communication module unit and for measuring the service data based on the type of service/content, used service time, frequency of service download, content information amount, unit information and control-type service.

14. A casing structure of the supplemental service meter gateway of claim 1 comprising:
a terminal casing including an input terminal into which an outdoor incoming line constituting the subscriber networks is inputted, and an output terminal out of which an indoor incoming line constituting a residential home indoor network is outputted, where the input terminal and the output terminal are arranged in parallel;
a power measurer casing connected to an upper end of the terminal casing, and intrinsically disposed with a power measurer, wherein a first cover coupled by a first sealing member for protecting the power measurer is disposed at the front of the power measurer casing; and
a service measurer casing attached to and detached from an upper end of the power measurer casing via a support member, and intrinsically disposed with a service measurer, wherein a second cover coupled by a second sealing member for protecting the service measurer is disposed at the front of the service measurer casing.

15. The casing structure as defined in claim 14, wherein the support member is protrusively provided at an upper end of the power measurer casing and is inserted into a support groove mounted at a lower end of the service measurer casing to be coupled to the service measurer casing.

16. The casing structure as defined in claim 14, wherein the second sealing member couples a first coupling member mounted at an upper end of the first cover with a second coupling member mounted at a lower end of the second cover.

17. A power line communication system using the supplemental service meter gateway of claim 1.

18. The system as defined in claim 17, further comprising:
a residential home indoor information control device for implementing a power line communication with the plurality of terminals of relevant dwellings via the residential home indoor network, providing an interface with subscribers, and, in response to the service request call of the subscribers, requesting the service data via the meter gateway; and
an external server for implementing a data communication with the regional information control device via the data communication network, providing the service data corresponding to the service request of the supplemental service meter gateway, and levying a charge based on the reading data and the service reading data provided from the regional information control device.

19. The system as defined in claim 18, wherein the supplemental service meter gateway uses a private code key in the relevant residential home indoor network to conduct data transmission and reception with the regional home indoor information control device and the plurality of terminals.

20. The system as defined in claim 19, wherein the private code key is registered with the service addition meter gateways, residential home indoor information control devices and plurality of terminals via a code key registration device capable of wireless infrared communication.

21. The system as defined in claim 17, wherein the supplemental service meter gateway uses the common code key within the subscriber network to conduct the data transmission and reception with the regional information control device.

22. The system as defined in claim 21, wherein the common code key is registered with the supplemental service meter gateway and the regional information control device via the code key registration device capable of wireless infrared communication.

23. The system as defined in claim 20, wherein the code key registration device is a Personal Digital Assistant, a notebook or a remote controller capable of wireless infrared communication.

24. The system as defined in claim 23, wherein the remote controller comprises:
an operation control input unit manipulated by a subscriber for controlling the write or read of the common code key and/or the private code key;
a wireless data communication module unit for reading the common code key and/or private code key transmitted from the supplemental service meter gateway or the wireless infrared port unit of the regional information control device, or for writing the common code key and/or private code key onto the supplemental service meter gateway or the wireless infrared port unit of the regional information control device;
a data storage for storing the common code key and/or private code key;
a state display unit for displaying a read or write process of the common code key and/or private code key; and
a central processing unit for storing at the data storage the common code key and/or private code key transmitted from the wireless data communication module unit in response to the control of the operation control input unit, or fetching the common code key and/or private code key stored at the data storage for transmission to the wireless data communication module unit.

25. The system as defined in claim 24, wherein the state display unit is comprised of an LED and is made to illuminate a red light when the read or write process fails, and to illuminate a green light when the read or write process succeeds.

26. A power line communication method, the method comprising the steps of:
(a) registering a common code key and/or private code key with a regional information control device, supplemental service meter gateway, residential home indoor information control device and terminal;
(b) prompting a subscriber to manipulate the residential home indoor information control device to transmit a service data request signal to an external server;
(c) prompting the outside server to transmit service data to the regional information control device via a data communication network in response to the service data request signal;
(d) prompting the regional information control device to encode the service data by using the common code key, and transmitting a first encoded data to the supplemental service meter gateway via subscriber networks;
(e) prompting the supplemental service meter gateway to decode the first data by using the common code key and to encode the first data again by using the private code key, and to transmit a second encoded data to the residential home indoor control device and the terminal via the residential home indoor network, and to measure the first data decoded based on the type of service/content, used service time, service/content download frequency, content information quantity, unit information, control service providing frequency to again encode the measured reading data by using the common code key and to transmit a third encoded data to the regional information control device via the subscriber networks;
(f) prompting the regional information control device to use the common code key to decode the third data and to transmit the decoded third data to the external server via the data communication network; and
(g) prompting the external server to allocate a service data charge based on the decoded third data.

27. The method as defined in claim 26, wherein the second data is decoded by the private code keys respectively registered with the residential home indoor information control device and the terminal after being provided to the residential home indoor information control device and the terminal in the above step (e).
